(19) United States
(12) Patent Application Publication
(10) Pub. No.: US 2018/0197152 A1
(43) Pub. Date: Jul. 12, 2018

(54) UPDATING AN ATTENDEE LIST ASSOCIATED WITH AN ELECTRONIC EVENT INVITATION

(71) Applicant: Microsoft Technology Licensing, LLC, Redmond, WA (US)

(72) Inventors: Roberto R.F. Mendes, Seattle, WA (US); Jaskaran Singh, Redmond, WA (US)

(73) Assignee: Microsoft Technology Licensing, LLC, Redmond, WA (US)

(21) Appl. No.: 15/403,916

(22) Filed: Jan. 11, 2017

(51) Int. Cl. G06Q 10/10; H04L 12/58

(52) U.S. Cl. CPC G06Q 10/1095; H04L 51/18; H04L 51/22

(57) ABSTRACT

Described is a system and method for automatically updating an attendee list of an electronic meeting invitation. The updated attendee list is sent to the meeting organizer and each invited attendee. The updated attendee list is included in an electronic message that is processed by an electronic communication application but does not appear in an electronic mailbox associated with the electronic communication application.

### BACKGROUND

Current email applications, or other types of electronic communication applications, typically have a calendaring application that enables users to schedule meetings, phone calls, appointments and so on. The email application also enables users to provide electronic invitations to other users to invite them to the meeting, the phone call, or the appointment. Once an invitation is received and/or accepted, the recipient can open the calendar item associated with the invitation and see a list of its attendees and their respective response statuses. However, that list is only accurate for the user that created the calendar item and is not updated for every attendee.

It is with respect to these and other general considerations that embodiments have been described. Also, although relatively specific problems have been discussed, it should be understood that the embodiments should not be limited to solving the specific problems identified in the background.

### SUMMARY

This disclosure generally relates to automatically updating an attendee list associated with an electronic event invitation. More specifically, the described embodiments enable each user that receives an electronic invitation for the event to see which invitees have responded to the electronic meeting invitation, including the type of response of each invitee, and which invitees have not responded. As additional responses are received, an update, in the form of an electronic message is provided to each invitee. The electronic message is in a format that enables the update to be processed by an electronic communication application associated with or used by the invitee. However, the electronic message itself does not appear in a recipient's electronic mailbox (e.g., an inbox) of the electronic communication application. The electronic message is processed and discarded.

Accordingly, disclosed herein is a system comprising a processing unit and a memory storing computer executable instructions which, when executed by the processing unit, causes the system to perform a method that includes sending a meeting invitation having meeting information to a plurality of recipients. Once the meeting invitation has been sent, a first response is received from a first recipient. A first electronic message that includes information about the first response is generated. The first electronic message is sent to each recipient in the plurality of recipients. However, the first electronic message is not received in an electronic message mailbox of an electronic communication application associated with each recipient but is processed by the electronic communication application to update the meeting information including the information about the first response to the meeting invitation.

Also described is a method for updating a list of attendees associated with a meeting invitation. The method includes receiving a plurality of responses to an electronic meeting invitation, wherein each response of the plurality of responses indicates an acceptance status of an invited attendee from a plurality of invited attendees and generating an electronic message that includes information corresponding to the acceptance status of each invited attendee from the plurality of invited attendees. In some embodiments, the electronic message has a format to enable delivery of the electronic message to an electronic mailbox of each invited attendee, regardless of whether the invited attendee provided one of the plurality of responses, but will not appear as an electronic message in the electronic mailbox of each invited attendee. The electronic message is then sent to each invited attendee.

The present disclosure also describes a computer-readable storage medium encoding computer-executable instructions which, when executed by a processing unit, causes the processing unit to perform a method comprising receiving an electronic event invitation from an event organizer and creating, in an electronic communication application, an event associated with the event invitation. An update to the event invitation may be subsequently received. The update is included in an electronic message that does not appear in an electronic mailbox of the electronic communication application. The event is automatically updated using the received update.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates a system for automatically updating an attendee list associated with an electronic meeting invitation according to an example embodiment.

FIG. 2 illustrates a method for automatically updating an attendee list associated with an electronic event invitation according to an example embodiment.

FIG. 3 illustrates another method for automatically updating an attendee list associated with an electronic meeting invitation according to an example embodiment.

FIG. 4 illustrates a method for displaying an updated list of attendees to an event in a calendar application associated with an electronic communication application according to an example embodiment.

FIG. 5 is a block diagram illustrating example physical components of a computing device with which aspects of the disclosure may be practiced.

FIGS. 6A and 6B are simplified block diagrams of a mobile computing device with which aspects of the present disclosure may be practiced.

FIG. 7 is a simplified block diagram of a distributed computing system in which aspects of the present disclosure may be practiced.

FIG. 8 illustrates a tablet computing device for executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Embodiments described herein are directed to a method and system for updating an attendee list associated with an electronic event invitation. More specifically, the present disclosure is directed to generating an electronic message that includes update information associated with the electronic event invitation. The update information may include a listing of invitees that have responded to the electronic event invitation, as well as the attendance status of each invitee. The electronic message is sent to all invitees regardless of whether or not they have responded to the initial electronic event invitation.

In addition to the above, an electronic message containing event organizer may also be generated and sent to all invitees. For example, an event organizer may add additional attendees, removes attendees, changes a received response from an invitee and so on. As these changes are made, the electronic message may be generated and sent to all invitees regardless of whether or not they have responded to the initial electronic event invitation.

The electronic message that includes the updated response information (or any other updates provided by the event organizer) has a format that enables it to be received and processed by an electronic communication application associated with each invitee but the electronic message does not appear in an electronic mailbox (such as, for example, an inbox) of the electronic communication application. Once the message is processed, an updated list of invitees, as well as their acceptance status, is provided to a calendar application associated with each invitee. As such, each invitee may receive and view, in real-time or substantially real-time, an accurate list of event attendees.

These and other embodiments will be discussed in more detail with respect to the figures below.

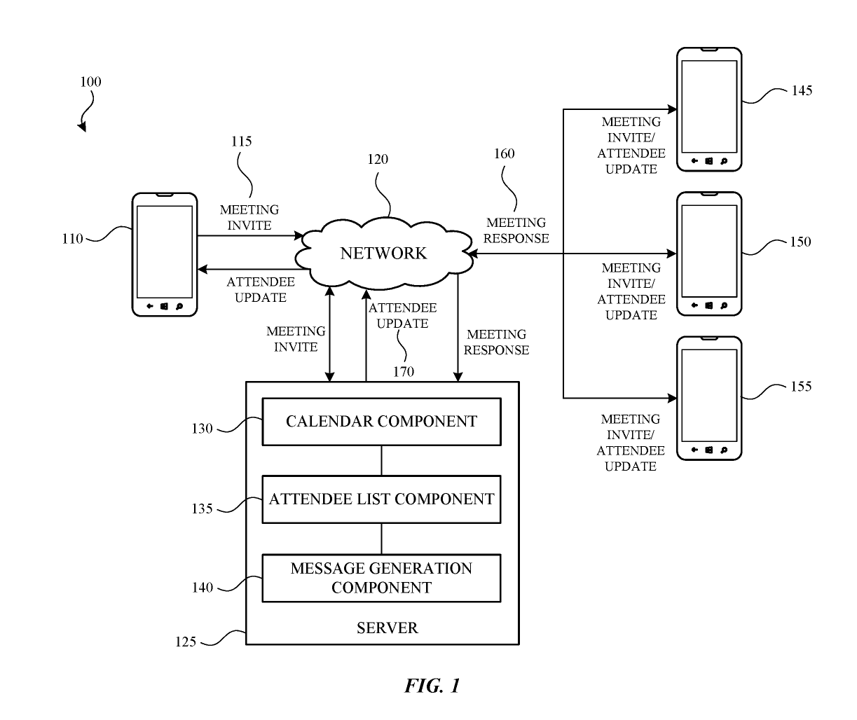

FIG. 1 illustrates an example system 100 for automatically updating an attendee list associated with an electronic meeting invitation. Although an electronic meeting invitation is specifically mentioned, the embodiments described herein may be used with any type of scheduled event in which electronic invitations or attendance requests are transmitted to other potential attendees or invitees. In some embodiments, the electronic invitations, the responses to the electronic invitations, as well as the updates to the responses or updates provided by a meeting organizer, are transmitted to the various invitees, and the event organizer, via an electronic communication application that is executing on a computing device 110.

In the embodiment shown in FIG. 1, the computing device 110 is a mobile computing device. However, other computing devices may be used. For example, the electronic communication application may be executed on mobile telephones, smart phones, tablet computing devices, smart watches, wearable computers, personal computers, desktop computers, laptop computers, gaming devices (e.g., Xbox®) and computers, televisions, or any other device that may use or otherwise execute an electronic communication application.

The electronic communication application executing on the computing device 110 (and on computing devices 145, 150 and 155) is configured to send and receive various types of electronic messages. These include, but are not limited to, email, text messages, video messages, audio messages and other forms of electronic communication. The electronic communication application may be a web application (e.g., Outlook web application by MICROSOFT CORP. of Redmond, Wash.) or a desktop application (e.g., Outlook desktop application by MICROSOFT CORP. of Redmond, Wash.).

In some instances, the electronic communication application includes various additional applications that provide additional features to a user. These additional applications may include a calendar application and/or a meeting application. The calendar application may display one or more meetings or appointments that a user has scheduled. Likewise, the meeting application may allow a user to act as a meeting or event organizer. For example, a user, acting as an event organizer, may create a meeting or an event at a specified time and date. The event organizer may also provide location information about the event, call-in information about the event and so on. The meeting organizer may also identify or otherwise invite a number of potential attendees or invitees to the event.

For example, an event organizer may access a calendar application of an electronic communication application that is executing on the computing device 110 and create an event. As described above, the event organizer may identify a number of invitees that are going to be invited to the event. Additional information about the event may also be provided by the event organizer such as described above.

Once the information is provided and an event is created, the computing device 110 transmits an electronic meeting invite 115 over a network 120 to a server 125 associated with the computing device 110. Once the server 125 receives the meeting invite 115, the meeting invite 115 is transmitted to the invitees that are identified in the meeting invite 115.

More specifically, and in some embodiments, the server 125 may include a calendar component 130, an attendee list component 135 and a message generation component 140. The server 125 may also have additional components that enables the transmission of various electronic messages to various computing devices.

Once the meeting invite 115 is received by the server 125, the calendar component 130 may cause a calendar application associated with the meeting organizer (e.g., a calendar application of an electronic communication application that is executing on the computing device 110) to provide an indication that the event has been scheduled on a particular day and at a particular time. Thus, when the meeting organizer (and any invitees that receive the meeting invite 115) open the calendar application, the event is shown on the identified day and at the identified time in the calendar application.

The calendar application may also display the list of individuals (described herein as invitees or attendees) that have been invited to the event. The list of individuals may include the name of the individual, the email address of the individual, a telephone number of the individual, a user name of the individual, a screen name of the individual and so on. As will be described below, the event may also be automatically updated to show which individuals have received the meeting invite 115 and the attendance status or acceptance status of each individual. In some implementations, the attendance status of each individual is updated in real-time or substantially real-time (e.g., the attendance status is updated once an individual responds to the meeting invite 115).

In some embodiments, the list of individuals that were invited to the event is also provided to an attendee list component 135. The attendee list component 135 is configured to track which invitees have responded to the meeting invite 115 as well as the attendance status of each invitee.

A message generation component 140 may also receive the list of invitees and generate an electronic message that is sent to each invitee. The electronic message may include the meeting invite 115. The electronic message, including the meeting invite 115, is sent to each invitee over the network 120.

In the example shown in FIG. 1, the various invitees are represented by computing device 145, computing device 150 and computing device 155. Computing device 145, computing device 150 and computing device 155 may be associated with the same server 125. As such, each computing device may utilize each of the components of the server 125. In other implementations, computing device 145, computing device 150 and computing device 155 may be associated with different servers. The different servers may have the same components as shown in FIG. 1 or may have different components. In some embodiments, each computing device may execute an electronic communication application with an associated calendar application.

Once the meeting invite 115 is sent to computing device 145, computing device 150 and computing device 155, the meeting invite 115 (in the form of an electronic message) may appear in an electronic mailbox of the electronic communication application. The invitee may view information about the event identified in the meeting invite 115. This information may include the time and date of the event, a list of potential attendees or invitees as well as other information.

The meeting invite 115 may enable the invitee to provide input that indicates whether or not the invitee is planning on attending the event. For example, each invitee may provide input to the meeting invite 115 (or on a calendar notification associated with the meeting invite 115 and displayed on the invitee's calendar application) that indicates their attendance status. The attendance status may indicate whether the invitee is planning on attending the event, is not planning on attending the event, has tentatively accepted or declined attending the event and so on.

Once the invitee has indicated their attendance status, a meeting response 160, containing the attendance status, is sent from the computing device (e.g., computing device 145) back to the server 125. When the meeting response 160 is received by the server 125, the attendee list component 135 updates the attendee list based on the meeting response 160.

For example, if the invitee using computing device 145 provides a meeting response 160 that indicates that they will be attending the event, the attendee list component 135 updates the attendee list accordingly. Likewise, if the invitee associated with computing device 150 provides a meeting response 160 that they will not be attending the event or that they are tentatively planning on attending the event, the attendee list component 135 updates the attendee list with this information.

The attendee list component 135 may communicate the updated attendee list to the message generation component 140. The message generation component 140 generates an electronic message that includes the updated attendee list, including the attendance status of each invitee and whether each invitee has provided a meeting response 160. The electronic message is then transmitted to the computing device 110 of the meeting organizer. The electronic message and the update is also transmitted, over the network 120, to computing devices 145, 150 and 155. In FIG. 1, the electronic message that includes the updated attendee list is represented as attendee update 170.

Once the electronic message containing the attendee update 170 is received, the calendar application associated with each invitee is automatically updated to reflect which invitees have responded to the initial meeting invite 115 as well as their attendance status. For example, the event that is provided on the calendar application of each invitee may reflect this information.

In some embodiments, the attendee update 170 is provided to each invitee regardless of whether the invitee has provided a meeting response 160. In the example described above, the invitee associated with computing device 145 provided a meeting response 160 that indicated that they would be attending the event. Likewise, the invitee associated with computing device 150 indicated that they were tentatively planning on attending the event. However, in this example, the invitee associated with computing device 155 did not provide a meeting response 160.

Regardless, each invitee, including the invitee associated with computing device 155, may still receive the attendee update 170. This information may also be provided in the calendar application of each invitee such as describe above. Thus, each invitee can see who has responded to the meeting invite 115, as well as the attendance status of each invited attendee.

In some implementations, the attendee update 170 may also be provided to each invitee when the event organizer changes or updates the attendee list. For example, the event organizer may add an additional attendee, remove an attendee, update a response provided by an attendee and so on. In such cases, the attendee update 170 will be provided to all invited attendees, including the newly added attendee, in the same manner as described herein.

In some embodiments, the attendee update 170 is provided as soon as a meeting response 160 is received. Thus, each invitee, as well as the event organizer, can see in real-time or substantially real-time, who has submitted a meeting response 160. In other implementations and as will be described below, the generation and transmission of the attendee update 170 may be batched such that updates are provided after certain batch criteria (e.g., time constraints, number of meeting responses 160 received and so on) have been met.

In some embodiments, the electronic message generated by the message generation component 140 has a format that enables the electronic message to be processed and subsequently discarded by the recipient's electronic communication application without appearing in the electronic mailbox of the electronic communication application. For example, the electronic message may be delivered to an electronic mailbox (e.g., an inbox) of an electronic communication application associated with each invitee without actually appearing in the electronic mailbox as an electronic message. As a result, the updates performed to the calendar items associated with the event may be invisible or substantially invisible to each invitee. For example, the electronic message is received and processed in the background of the electronic message application without input from the recipient.

In some aspects, the electronic message containing the attendee update 170 may be a lightweight, invisible electronic message that is meant to be used for internal purposes. That is, the message is not interactive (e.g., the recipient cannot interact with the electronic message).

In other implementations, the electronic message may be a message that is designed for doing updates of calendar items. In some cases, these updates or repairs are done in the background. In some embodiments, these electronic messages may be lightweight as they don't have a message body or attachments and are not meant to be interacted with by a user.

In yet other implementations, the electronic message containing the attendee update 170 may be a combination of the two messages described above. For example, in some implementations, a particular message, or a message having a particular format, may be designed to only be used in a particular datacenter. Once the message crosses the datacenter boundary, it may lose its “invisibility” characteristics. Accordingly, the message may be augmented with or changed to the update message described above which enables the attendee update 170 message to retain its invisibility characteristics. Accordingly, the attendee update 170 may still be delivered to the invitee without being seen by the invitee.

As additional meeting responses 160 are received, additional attendee updates 170 may be generated and provided to the meeting organizer and each invitee. For example, if the invitee associated with computing device 155 submits a meeting response 160 that they will not be attending the event, the meeting response 160 is provided to the attendee list component 135 such as described above. The message generation component 140 generates an electronic message and the attendee update 170 and transmits it to each invitee and the event organizer.

Further, if a particular invitee changes or otherwise updates their initial meeting response 160, the server 125 may be configured to generate and provide an attendee update message such as described above. For example, if the invitee associated with computing device 150 changes their meeting response 160 from tentatively attending to attending, the meeting response 160 is provided to the server 125 and another attendee update message 170 is generated and provided to each invitee and the meeting organizer. Each time an attendee update message is received, a calendar application associated with the meeting organizer and each invitee is automatically updated with the newly received information.

In some embodiments, the calendar application may include an indicator, a marking, a timestamp, be color coded or provide some indication as to when the attendee list was last updated. As such, each invitee, as well as the meeting organizer, may be able to accurately determine when the invitee list was last updated.

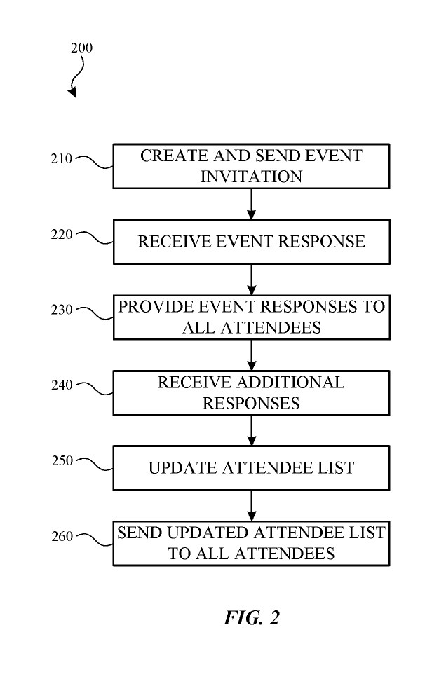

FIG. 2 illustrates a method 200 for automatically updating an attendee list associated with an electronic event invitation according to an example embodiment. The method 200 may be used by the system 100 described above with respect to FIG. 1.

Method 200 begins at operation 210 in which an event invitation is created by an event organizer. In some embodiments, the event invitation may be created or generated by an electronic communication application. For example, the electronic communication application may include a calendar application that enables users to create an event, specify the date, time, and location of the event and invite a number of potential attendees to the event. The potential attendees may be identified by a name, an email address, a phone number, a user name, a screen name and so on. Once the event invitation is created, the electronic communication application sends the event invitation to the identified attendees.

Flow then proceeds to operation 220 in which an event response is received. The event response is an electronic message that is received from one or more of the identified attendees that received the event invitation. The event response may include an identifier associated with the attendee and an attendance response. In some embodiments, the attendance response includes an indication as to whether or not the attendee is planning on attending the event.

In operation 230 the received event responses are provided to each attendee. For example, when an event response is received, an electronic message is automatically generated. The electronic message includes information about which attendees have responded to the initial event invitation as well as their attendance status.

In some implementations, the electronic message, and the associated update, only includes responses that have been received since the last electronic message was generated and sent. For example, if a first response was received and a first update was generated and sent to each attendee, the first response is not included in subsequent updates. In other implementations, the electronic message includes all received responses, regardless of whether or not that information was sent in a previous update.

As described above, the electronic message is provided to each attendee regardless of whether the attendee has provided a response. As such, each attendee can see who has responded to the event invitation as well as the attendance status of each attendee in real-time or substantially real-time.

As also described, the electronic message that includes the update and that is sent to each attendee has a format that enables the electronic message to be sent to, and received by, an electronic mailbox of the attendee's electronic communication application but does not appear as a received item. That is, the electronic message is essentially invisible to the user but the information contained in the message may be used to update the event indication in a calendar application of the attendee's electronic communication application.

Flow then proceeds to operation 240 and one or more additional responses to the event invitation may be received. In some embodiments, the one or more additional responses may be an update to a previously received response (e.g., an attendee changing their previously submitted attendance status) or new response from an attendee had not yet provided a response. In another implementation, the additional response may include an update to the attendee list provided by the event organizer (e.g., the event organizer may add or remove an attendee, change a previously received response).

Flow then proceeds to operation 250 and the attendee list is updated with the newly received information. In operation 260, the updated attendee list is provided to all of the attendees. As discussed above, the updated attendee list is provided in an electronic message that has a format such as described above.

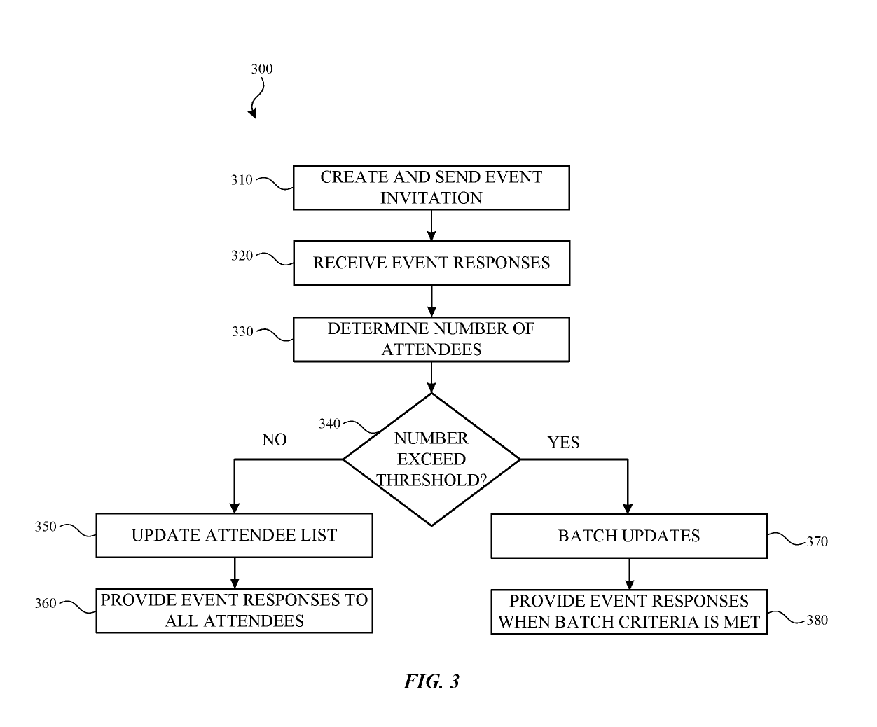

FIG. 3 illustrates another method 300 for automatically updating an attendee list associated with an electronic meeting invitation according to an example embodiment. Like method 200 described above with respect to FIG. 2, method 300 may be used by the system 100 that was described with respect to FIG. 1. However, in method 300, the updates are batched based on a number of attendees that are invited to the event.

For example, if an event organizer invited one thousand people to an event, one thousand people would reply with their attendance status. Each one of those responses would be processed by the event organizer's server and, as a result, the server would send thousands of e-mails to keep the list of attendees up-to-date. Thus, even though messages having this particular format (e.g., control flow messages) have a low priority in a message hierarchy and don't count towards a user's quota, these messages still occupy space in the queue. Accordingly a batching scheme may be used to provide periodic updates to each invitee as well as the meeting organizer.

Method 300 begins at operation 310 in which an event invitation is created and sent. Operation 310 may be equivalent to operation 210 described above. Flow then proceeds to operation 320 and one or more event responses are received. Operation 320 may be equivalent to operation 220 described above.

In operation 330 a number of attendees is determined. In some embodiments, the determination may be made by an attendee list component such as described above with reference to FIG. 1. In other implementations, the calendar application of an electronic communication application may be configured to determine the number of attendees. Although specific examples have been given, the number of attendees may be determined in any number of ways.

Flow then proceeds to operation 340 and a determination is made as to whether the number of attendees exceeds a threshold. Although a thousand attendees is specifically mentioned in the example above, the threshold used in operation 340 may be any desired number.

If the number of attendees does not exceed a threshold, flow proceeds to operation 350 and the attendee list is updated such as described above. In operation 360, the updated attendee list, including all responses that have been received, are provided to all of the attendees. In some implementations, the updated attendee list is provided to each attendee as soon as the updates are received.

However, if it is determined in operation 340 that the number of attendees exceeds a threshold, flow proceeds to operation 370 and the updates to the attendee list are batched.

In some embodiments, a time-based batching scheme may be used. In the time-based batching scheme, when a response is received that triggers an update, an electronic message containing the update is created such as described above. However, a delayed send option is associated with the electronic message. As such, the electronic message with the update will not be sent until a specified amount of time (e.g., 60 minutes or less) has passed. If another response is received during that time frame, the electronic message is either updated or replaced so that the electronic message includes the most recent information.

Updates may continue to be received up until the time expires. For example, when an update is received, the original timer may still run. However, once the timer expires, the electronic message, and any and all updates that were received during that time period, are provided to the attendees. Thus, regardless of the number of updates that are received, the electronic message is sent once the specified amount of time has passed.

In another implementation, the timer may be reset after a response from an attendee is received. Thus, if the timer is a 60 minute timer and a new response or an update is received after 59 minutes, the timer is reset to 60 minutes. Once the timer expires, the electronic message, including the updated attendee list and the updated attendance status, is provided to each attendee.

In another implementation, the batching scheme may be based on the number of responses received. For example, if an event organizer invited 100 people to the event, an electronic message with the update may be provided to each attendee when a certain number of responses (e.g., 10) have been received.

In yet another implementation, the batching scheme may be selective. For example, an event in which few attendees have been invited will not generate too much traffic. However, the attendees of these events may be more likely to be interested in the attendance status of the other attendees. As such, the system can implement a batching scheme for events whose attendee count is past a certain threshold.

In still yet other implementations, if the number of attendees exceeds a particular threshold, (e.g., more than 50) the system may choose not to provide any updates or to provide updates to select individuals (e.g., the event organizer and/or other specified attendees).

When a batching scheme is implemented, flow proceeds to operation 380 event responses and/or updates are provided when the batch criteria is met. As previously described, the event response and/or the updates are provided in an electronic message and provided to each attendee.

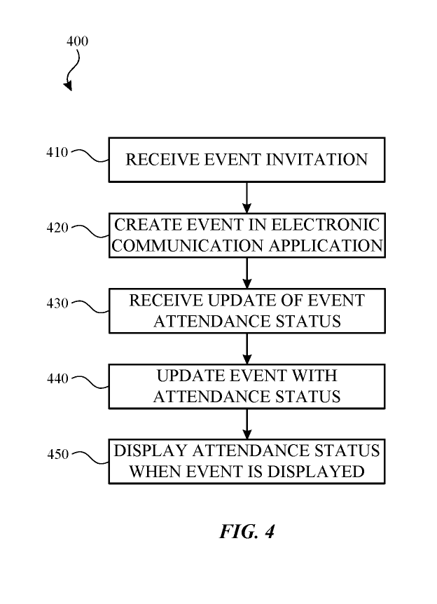

FIG. 4 illustrates a method 400 for displaying an updated list of attendees to an event in a calendar application associated with an electronic communication application according to an example embodiment. In some embodiments, the method 400 may be implemented by a system 100 such as described above.

Method 400 begins at operation 410 in which an event invitation is received by a computing device associated with the recipient of the event invitation. The event invitation may be sent from an event organizer such as described above.

Once the event invitation is received, flow proceeds to operation 420 and an event in an electronic communication application is created. For example, the electronic communication application may include a calendar application that displays various meetings, events, appointments and so on. Thus, when the event invitation is received, information about the event, including the date, time, location and a list of invitees or potential attendees may be displayed to the recipient.

In operation 430, an update of event attendance statuses is received by the electronic communication application. In embodiments, the update may include updates to the date of the event, the time of the event, the location of the event, addition of one or more invitees, removal of one or more attendees and/or an attendance status of one or more invitees. As described above, the update may be sent in an electronic message that is received by the electronic communication application but is not shown in an electronic mailbox of the electronic communication application.

Flow then proceeds to operation 440 and the event in the calendar application is updated to show the updated attendance status and/or any other information about the event that has been provided. In operation 450, the attendance status of each invitee is displayed when the event is displayed in the calendar application.

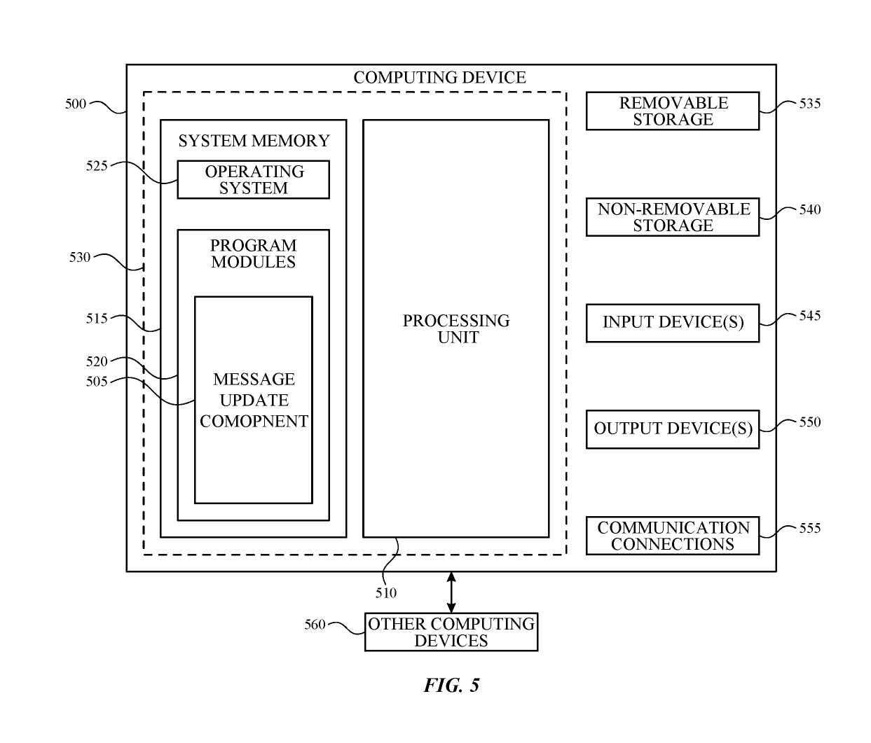

FIGS. 5-8 and the associated descriptions provide a discussion of a variety of operating environments in which aspects of the disclosure may be practiced. However, the devices and systems illustrated and discussed with respect to FIGS. 5-8 are for purposes of example and illustration and are not limiting of a vast number of electronic device configurations that may be utilized for practicing aspects of the disclosure, as described herein.

FIG. 5 is a block diagram illustrating physical components (e.g., hardware) of an electronic device 500 with which aspects of the disclosure may be practiced. The components of the electronic device 500 described below may have computer executable instructions for generating a mailto link in an electronic communication application such as described above.

In a basic configuration, the electronic device 500 may include at least one processing unit 510 and a system memory 515. Depending on the configuration and type of electronic device, the system memory 515 may comprise, but is not limited to, volatile storage (e.g., random access memory), non-volatile storage (e.g., read-only memory), flash memory, or any combination of such memories. The system memory 515 may include an operating system 525 and one or more program modules 520 suitable for parsing received responses, generating electronic messages, updating attendee lists and so on.

The operating system 525, for example, may be suitable for controlling the operation of the electronic device 500. Furthermore, embodiments of the disclosure may be practiced in conjunction with a graphics library, other operating systems, or any other application program and is not limited to any particular application or system. This basic configuration is illustrated in FIG. 5 by those components within a dashed line 530.

The electronic device 500 may have additional features or functionality. For example, the electronic device 500 may also include additional data storage devices (removable and/or non-removable) such as, for example, magnetic disks, optical disks, or tape. Such additional storage is illustrated in FIG. 5 by a removable storage device 535 and a non-removable storage device 540.

As stated above, a number of program modules and data files may be stored in the system memory 515. While executing on the processing unit 510, the program modules 520 (e.g., the message update component 505) may perform processes including, but not limited to, the aspects, as described herein.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality, described herein, with respect to the capability of the client to switch protocols may be operated via application-specific logic integrated with other components of the electronic device 500 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The electronic device 500 may also have one or more input device(s) 545 such as a keyboard, a trackpad, a mouse, a pen, a sound or voice input device, a touch, force and/or swipe input device, etc. The output device(s) 550 such as a display, speakers, a printer, etc. may also be included. The aforementioned devices are examples and others may be used. The electronic device 500 may include one or more communication connections 555 allowing communications with other electronic devices 560. Examples of suitable communication connections 555 include, but are not limited to, radio frequency (RF) transmitter, receiver, and/or transceiver circuitry; universal serial bus (USB), parallel, and/or serial ports.

The term computer-readable media as used herein may include computer storage media. Computer storage media may include volatile and nonvolatile, removable and non-removable media implemented in any method or technology for storage of information, such as computer readable instructions, data structures, or program modules.

The system memory 515, the removable storage device 535, and the non-removable storage device 540 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the electronic device 500. Any such computer storage media may be part of the electronic device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

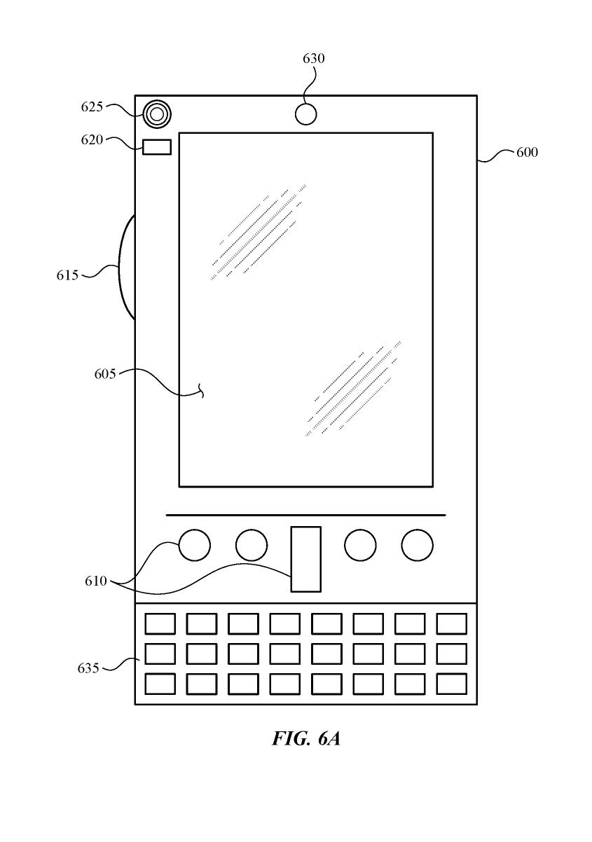

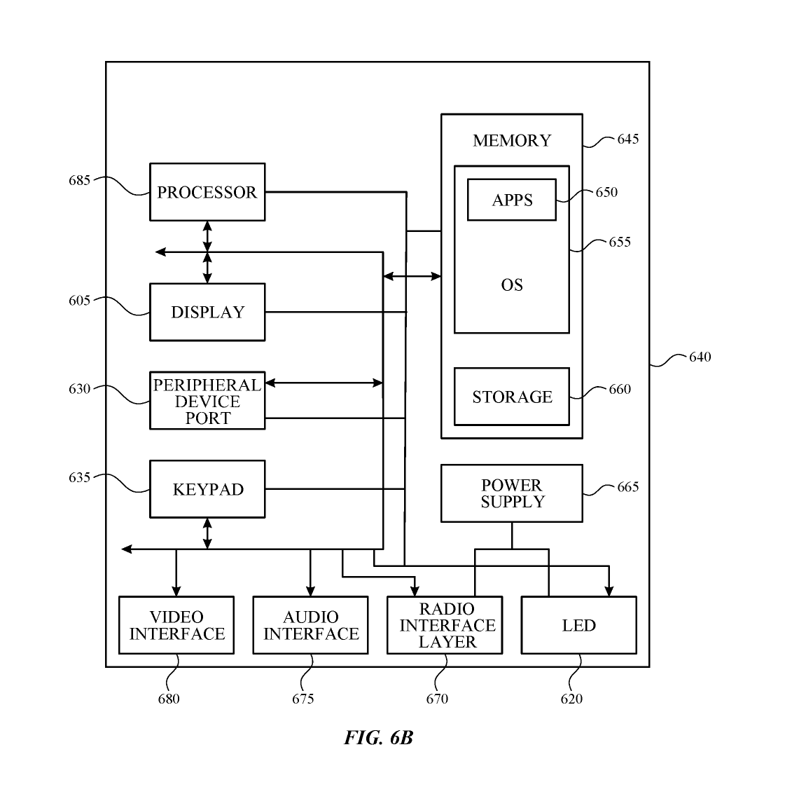

FIGS. 6A and 6B illustrate a mobile electronic device 600, for example, a mobile telephone, a smart phone, wearable computer (such as a smart watch), a tablet computer, a laptop computer, and the like, with which embodiments of the disclosure may be practiced. With reference to FIG. 6A, one aspect of a mobile electronic device 600 for implementing the aspects is illustrated.

In a basic configuration, the mobile electronic device 600 is a handheld computer having both input elements and output elements. The mobile electronic device 600 typically includes a display 605 and one or more input buttons 610 that allow the user to enter information into the mobile electronic device 600. The display 605 of the mobile electronic device 600 may also function as an input device (e.g., a display that accepts touch and/or force input).

If included, an optional side input element 615 allows further user input. The side input element 615 may be a rotary switch, a button, or any other type of manual input element. In alternative aspects, mobile electronic device 600 may incorporate more or less input elements. For example, the display 605 may not be a touch screen in some embodiments. In yet another alternative embodiment, the mobile electronic device 600 is a portable phone system, such as a cellular phone. The mobile electronic device 600 may also include an optional keypad 635. Optional keypad 635 may be a physical keypad or a “soft” keypad generated on the touch screen display.

In various embodiments, the output elements include the display 605 for showing a graphical user interface (GUI), a visual indicator 620 (e.g., a light emitting diode), and/or an audio transducer 625 (e.g., a speaker). In some aspects, the mobile electronic device 600 incorporates a vibration transducer for providing the user with tactile feedback. In yet another aspect, the mobile electronic device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one aspect of a mobile electronic device 600. That is, the mobile electronic device 600 can incorporate a system (e.g., an architecture) 640 to implement some aspects. In one embodiment, the system 640 is implemented as a “smart phone” capable of running one or more applications (e.g., browser, e-mail, calendaring, contact managers, messaging clients, games, media clients/players, content selection and sharing applications and so on). In some aspects, the system 640 is integrated as an electronic device, such as an integrated personal digital assistant (PDA) and wireless phone.

One or more application programs 650 may be loaded into the memory 645 and run on or in association with the operating system 655. Examples of the application programs include phone dialer programs, e-mail programs, personal information management (PIM) programs, word processing programs, spreadsheet programs, Internet browser programs, messaging programs, and so forth.

The system 640 also includes a non-volatile storage area 660 within the memory 645. The non-volatile storage area 660 may be used to store persistent information that should not be lost if the system 640 is powered down.

The application programs 650 may use and store information in the non-volatile storage area 660, such as email or other messages used by an email application, and the like. A synchronization application (not shown) also resides on the system 640 and is programmed to interact with a corresponding synchronization application resident on a host computer to keep the information stored in the non-volatile storage area 660 synchronized with corresponding information stored at the host computer.

The system 640 has a power supply 665, which may be implemented as one or more batteries. The power supply 665 may further include an external power source, such as an AC adapter or a powered docking cradle that supplements or recharges the batteries.

The system 640 may also include a radio interface layer 670 that performs the function of transmitting and receiving radio frequency communications. The radio interface layer 670 facilitates wireless connectivity between the system 640 and the “outside world,” via a communications carrier or service provider. Transmissions to and from the radio interface layer 670 are conducted under control of the operating system 655. In other words, communications received by the radio interface layer 670 may be disseminated to the application programs 650 via the operating system 655, and vice versa.

The visual indicator 620 may be used to provide visual notifications, and/or an audio interface 675 may be used for producing audible notifications via an audio transducer (e.g., audio transducer 625 illustrated in FIG. 6A). In the illustrated embodiment, the visual indicator 620 is a light emitting diode (LED) and the audio transducer 625 may be a speaker. These devices may be directly coupled to the power supply 665 so that when activated, they remain on for a duration dictated by the notification mechanism even though the processor 685 and other components might shut down for conserving battery power. The LED may be programmed to remain on indefinitely until the user takes action to indicate the powered-on status of the device.

The audio interface 675 is used to provide audible signals to and receive audible signals from the user (e.g., voice input such as described above). For example, in addition to being coupled to the audio transducer 625, the audio interface 675 may also be coupled to a microphone to receive audible input, such as to facilitate a telephone conversation. In accordance with embodiments of the present disclosure, the microphone may also serve as an audio sensor to facilitate control of notifications, as will be described below.

The system 640 may further include a video interface 680 that enables an operation of peripheral device 630 (e.g., on-board camera) to record still images, video stream, and the like. The captured images may be provided to the artificial intelligence entity advertisement system such as described above.

A mobile electronic device 600 implementing the system 640 may have additional features or functionality. For example, the mobile electronic device 600 may also include additional data storage devices (removable and/or non-removable) such as, magnetic disks, optical disks, or tape. Such additional storage is illustrated in FIG. 6B by the non-volatile storage area 660.

Data/information generated or captured by the mobile electronic device 600 and stored via the system 640 may be stored locally on the mobile electronic device 600, as described above, or the data may be stored on any number of storage media that may be accessed by the device via the radio interface layer 670 or via a wired connection between the mobile electronic device 600 and a separate electronic device associated with the mobile electronic device 600, for example, a server computer in a distributed computing network, such as the Internet. As should be appreciated such data/information may be accessed via the mobile electronic device 600 via the radio interface layer 670 or via a distributed computing network. Similarly, such data/information may be readily transferred between electronic devices for storage and use according to well-known data/information transfer and storage means, including electronic mail and collaborative data/information sharing systems.

As should be appreciated, FIG. 6A and FIG. 6B are described for purposes of illustrating the present methods and systems and is not intended to limit the disclosure to a particular sequence of steps or a particular combination of hardware or software components.

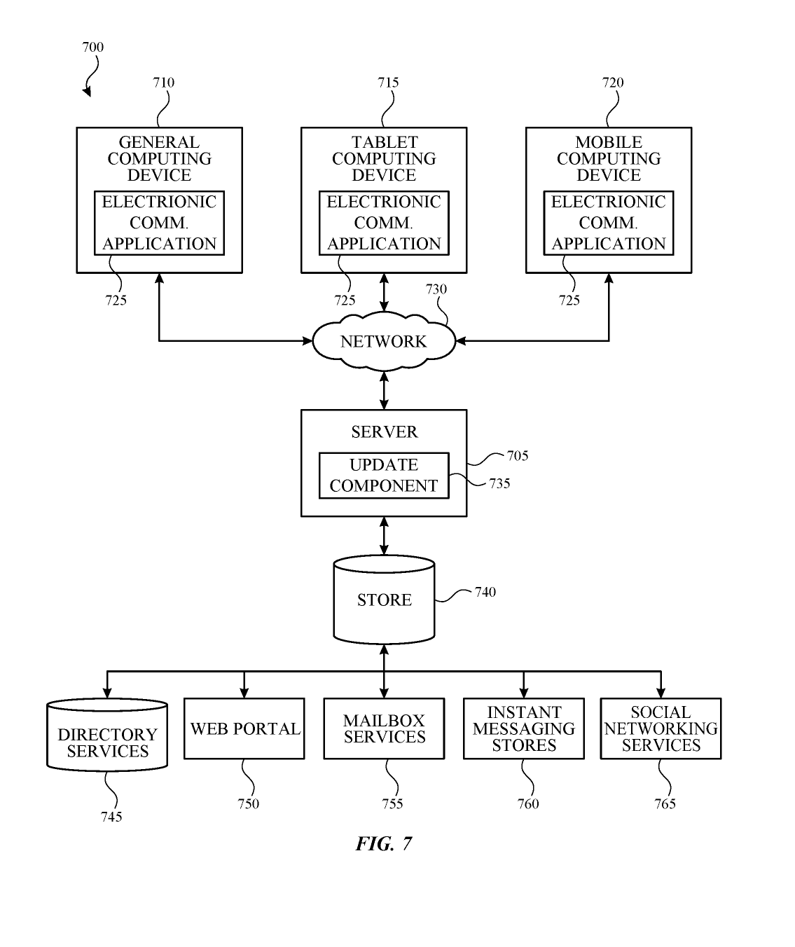

FIG. 7 illustrates one aspect of the architecture of a system 700 for providing updates to an attendee list of an event such as described herein. The system may include a general electronic device 710 (e.g., personal computer), tablet electronic device 715, or mobile electronic device 720, as described above. Each of these devices may include an electronic communication application 725 and/or an associated calendar application such as described. The electronic communication application is configured to provide event invitations to a number of individuals. When responses are received, an update component 735 on a server 705, provides, over the network 730, real-time or substantially real-time updates to the electronic communication application 725 of the event organizer and to electronic communication applications associated with each invited individual.

In some aspects, the update component 735 may receive various types of information or content that is stored by the store 740 or transmitted from a directory service 745, a web portal 750, mailbox services 755, instant messaging stores 760, or social networking services 765.

By way of example, the aspects described above may be embodied in a general electronic device 710 (e.g., personal computer), a tablet electronic device 715 and/or a mobile electronic device 720 (e.g., a smart phone). Any of these embodiments of the electronic devices may obtain content from or provide data to the store 740.

As should be appreciated, FIG. 7 is described for purposes of illustrating the present methods and systems and is not intended to limit the disclosure to a particular sequence of steps or a particular combination of hardware or software components.

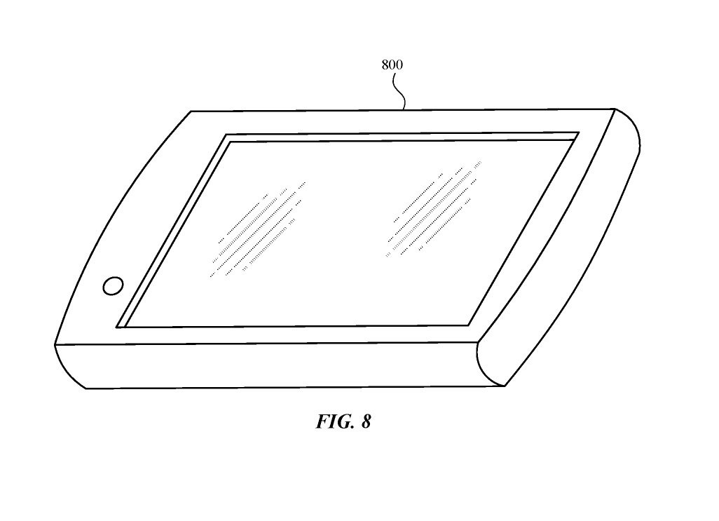

FIG. 8 illustrates an example tablet electronic device 800 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board electronic device displays or via remote display units associated with one or more electronic devices.

For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated electronic device is equipped with detection (e.g., camera) functionality for capturing and interpreting user gestures for controlling the functionality of the electronic device, and the like.

As should be appreciated, FIG. 8 is described for purposes of illustrating the present methods and systems and is not intended to limit the disclosure to a particular sequence of steps or a particular combination of hardware or software components.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
a processing unit; and
a memory storing computer executable instructions which, when executed by the processing unit, causes the system to perform a method, comprising:
sending a meeting invitation having meeting information to a plurality of recipients;
receiving a first response from a first recipient;
generating a first electronic message that includes information about the first response;
sending the first electronic message to each recipient in the plurality of recipients, wherein the first electronic message is not received in an electronic mailbox of an electronic communication application associated with each recipient but is processed by the electronic communication application to update the meeting information including the information about the first response to the meeting invitation.

2. The system of claim 1, further comprising instructions for:
receiving a second response from a second recipient;
generating a second electronic message that includes updated information corresponding to the second response; and
sending the second electronic message to each recipient of the plurality of recipients, wherein the second electronic message is not received in the electronic mailbox of the electronic communication application associated with each recipient but is processed by the electronic communication application to update the meeting information including the information about the second response to the meeting invitation.

3. The system of claim 1, wherein the electronic message is configured to update a calendar item associated with the meeting invitation.

4. The system of claim 3, wherein the calendar item is configured to display a type of response from each recipient in the plurality of recipients.

5. The system of claim 1, further comprising instructions for batching the first electronic message with another electronic message when a number of recipients exceeds a threshold.

6. The system of claim 5, further comprising instructions for sending either the first electronic message or the another electronic message when a batching criteria has been met.

7. The system of claim 6, wherein the batching criteria is a time-based criteria.

8. The system of claim 6, wherein the batching criteria is associated with a number of received responses.

9. The system of claim 1, wherein the first electronic message does not include a message body.

10. The system of claim 1, wherein the first electronic message is not interactive.

11. A method for updating a list of attendees associated with a meeting invitation, comprising:
receiving a plurality of responses to an electronic meeting invitation, wherein each response of the plurality of responses indicates an acceptance status of an invited attendee from a plurality of invited attendees;
generating an electronic message that includes information corresponding to the acceptance status of each invited attendee from the plurality of invited attendees, wherein the electronic message has a format to enable delivery to an electronic mailbox of each invited attendee, regardless of whether the invited attendee provided one of the plurality of responses, but will not appear as an electronic message in the electronic mailbox of each invited attendee; and
sending the electronic message to each invited attendee.

12. The method of claim 11, wherein the acceptance status of each invited attendee is provided to every other invited attendee in the plurality of invited attendees.

13. The method of claim 11, wherein the electronic message automatically updates a calendar item associated with the electronic meeting invitation.

14. The method of claim 11, wherein the electronic message is sent when the plurality of responses exceeds a threshold.

15. The method of claim 11, wherein the electronic message is sent after a threshold amount of time has passed since the electronic meeting invitation was sent to the plurality of invited attendees.

16. The method of claim 11, wherein the electronic message is associated with a calendar application.

17. The method of claim 11, further comprising:
generating another electronic message when another response to the electronic meeting invitation is received, the another electronic message indicating an attendance status of another invited attendee; and
sending the another electronic message to each invited attendee of the plurality of invited attendees, wherein the another electronic message will not appear as an electronic message in the electronic mailbox of each invited attendee.

18. A computer-readable storage medium encoding computer-executable instructions which, when executed by a processing unit, causes the processing unit to perform a method comprising:
receiving an electronic event invitation from an event organizer;
creating, in an electronic communication application, an event associated with the event invitation;
receiving an update to the event invitation, wherein the update is included in an electronic message that does not appear in an electronic mailbox of the electronic communication application; and
automatically updating the event using the received update.

19. The computer-readable storage medium of claim 18, wherein the update includes an attendance status of a plurality of attendees that received the event invitation from the event organizer.

20. The computer-readable storage medium of claim 19, wherein automatically updating the event comprises updating the attendance status of the plurality of attendees.
